(19) United States
(12) Patent Application Publication
(10) Pub. No.: US 2025/0159338 A1
(43) Pub. Date: May 15, 2025

(54) IMAGING SYSTEM, IMAGING APPARATUS, METHOD FOR CONTROLLING IMAGING SYSTEM, METHOD FOR CONTROLLING IMAGING APPARATUS, AND STORAGE MEDIUM

(71) Applicant: CANON KABUSHIKI KAISHA, Tokyo (JP)

(72) Inventor: MITSUMASA ABE, Kanagawa (JP)

(21) Appl. No.: 18/938,862

(22) Filed: Nov. 6, 2024

(30) Foreign Application Priority Data
Nov. 10, 2023 (JP) 2023-192528

(51) Int. Cl. H04N 23/661

(52) U.S. Cl. CPC H04N 23/661

(57) ABSTRACT

An imaging system includes first and second imaging apparatuses. The first imaging apparatus includes a first generation unit configured to generate a periodic imaging timing synchronized with the second imaging apparatus, a first communication unit configured to transmit a trigger signal to the second imaging apparatus based on an imaging instruction, and a first imaging control unit configured to perform control such that imaging is performed at the imaging timing generated by the first generation unit after the trigger signal is transmitted. The second imaging apparatus includes a second generation unit configured to generate a periodic imaging timing synchronized with the first imaging apparatus, a second communication unit configured to receive the trigger signal from the first imaging apparatus, and a second imaging control unit configured to perform control such that imaging is performed at the imaging timing generated by the second generation unit after the trigger signal is received.

### BACKGROUND

### Field

The present disclosure relates to an imaging system, an imaging apparatus, a method for controlling the imaging system, a method for controlling the imaging apparatus, and a storage medium.

### Description of the Related Art

Technologies for synchronizing a plurality of devices to operate as a system have been used in many technical fields. Examples of such technologies include stadium vision and volumetric studio, which use images simultaneously captured by a plurality of cameras and switch among the images from a certain viewpoint to create a free-viewpoint image.

In order to obtain high-quality free-viewpoint images, imaging is to be accurately synchronized. As a technique for achieving time synchronization among communication terminals that control cameras, Precision Time Protocol (hereinafter, PTP) is used.

In performing synchronous imaging by a plurality of cameras, it is known that a device (sender camera) that triggers the synchronous imaging transmits a signal including time information indicating the timing for synchronous imaging. The sender camera and devices (receiver cameras) that have received the signal including the time information from the sender camera perform imaging at the time indicated by the signal, thus achieving the synchronous imaging.

Japanese Patent Application Publication No. 2002-247408 discusses a method for performing simultaneous imaging with which each camera generates a frame synchronization signal based on a time stamp, which indicates a future time, generated by the sender camera, and each camera generates image data based on the generated frame synchronization signal.

If each camera is daisy-chained with an IEEE 1394 interface, the time for packets to reach the imaging apparatus serving as an end-use device becomes longer as the number of imaging apparatuses increases. Thus, the future time specified by the timestamp lags behind the timing specified by a photographer. This causes a discrepancy between the timing at which the photographer intended to perform imaging and the timing at which imaging is actually performed.

### SUMMARY

The present disclosure is directed to enabling synchronous imaging at a timing close to that intended by a photographer.

According to an aspect of the present disclosure, an imaging system includes a first imaging apparatus and a second imaging apparatus. The first imaging apparatus includes a first generation unit configured to generate a periodic imaging timing synchronized with the second imaging apparatus, a first communication unit configured to transmit a trigger signal to the second imaging apparatus based on an imaging instruction, and a first imaging control unit configured to perform control such that imaging is performed at the imaging timing generated by the first generation unit after the trigger signal is transmitted. The second imaging apparatus includes a second generation unit configured to generate a periodic imaging timing synchronized with the first imaging apparatus, a second communication unit configured to receive the trigger signal from the first imaging apparatus, and a second imaging control unit configured to perform control such that imaging is performed at the imaging timing generated by the second generation unit after the trigger signal is received.

Further features of the present disclosure will become apparent from the following description of exemplary embodiments with reference to the attached drawings.

### BRIEF DESCRIPTION OF THE DRAWINGS

FIG. 1 is a diagram illustrating a configuration example of a synchronous imaging system.

FIG. 2 is a diagram illustrating a configuration example of a sender camera.

FIG. 3 is a flowchart illustrating initial settings of a camera.

FIG. 4 is a diagram illustrating a time synchronization sequence.

FIG. 5 is a diagram illustrating a synchronous imaging sequence.

FIG. 6 is a flowchart of synchronous imaging of the sender camera.

FIG. 7 is a flowchart of synchronous imaging of receiver cameras.

FIG. 8 is a flowchart of synchronous imaging of the sender camera.

FIG. 9 is a diagram illustrating a synchronous imaging sequence.

FIG. 10 is a flowchart of synchronous imaging of the sender camera.

FIG. 11 is a diagram illustrating a synchronous imaging sequence.

FIG. 12 is a diagram illustrating an Open Systems Interconnection (OSI) reference model.

### DESCRIPTION OF THE EMBODIMENTS

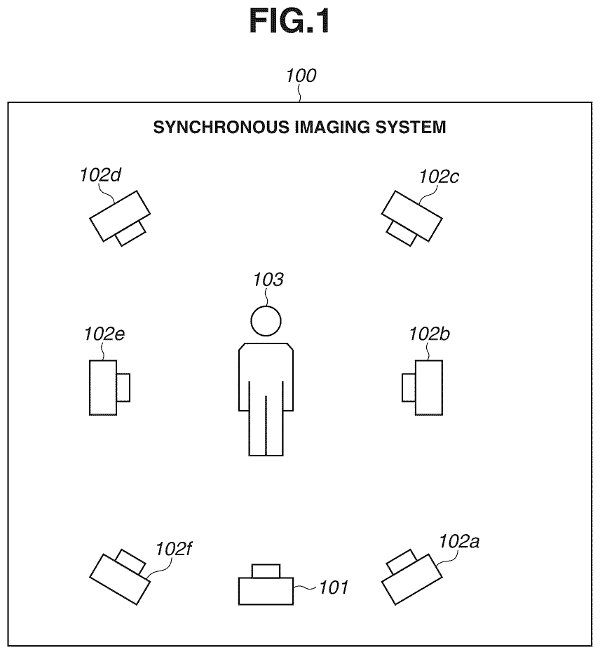

A first exemplary embodiment will be described below. FIG. 1 is a diagram illustrating a configuration example of a synchronous imaging system 100 according to the first exemplary embodiment. The synchronous imaging system 100 has a sender camera 101 and a plurality of receiver cameras 102a to 102f. The sender camera 101 is an example of an imaging apparatus. The receiver cameras 102a to 102f are also examples of imaging apparatuses.

The sender camera 101 is held by a photographer, and determines the timing for capturing an image of an imaging target 103. The receiver cameras 102a to 102f perform imaging in synchronization with the sender camera 101. The sender camera 101 and the receiver cameras 102a to 102f are directed toward the imaging target 103.

The sender camera 101 and the receiver cameras 102a to 102f are synchronized in time via a network. This network is a wireless local area network (LAN) conforming to the IEEE standards, which is Wi-Fi (registered trademark), but it may be configured with a combination of a wired LAN, an interconnect (InfiniBand), industrial Ethernet, and the like. The network is not limited to these, and may be another type of network.

The sender camera 101 is held by the photographer, and in response to receiving an imaging instruction from the photographer, distributes the instruction. In the present exemplary embodiment, the sender camera 101 and the receiver cameras 102a to 102f are identical in configuration and are called differently according to their roles. The sender camera 101 and the receiver cameras 102a to 102f may be different in configuration. The sender camera 101 may be a communication device, such as a smartphone or a personal computer (PC).

The receiver cameras 102a to 102f perform imaging in response to the imaging instruction distributed from the sender camera 101. In the present exemplary embodiment, the receiver cameras 102a to 102f are identical in configuration to the sender camera 101, and are initially set to receiver cameras.

Hereinafter, the sender camera 101 and the receiver cameras 102a to 102f will be collectively referred to as “each camera”.

The imaging target 103 is a target to be imaged by the sender camera 101 and the receiver cameras 102a to 102f.

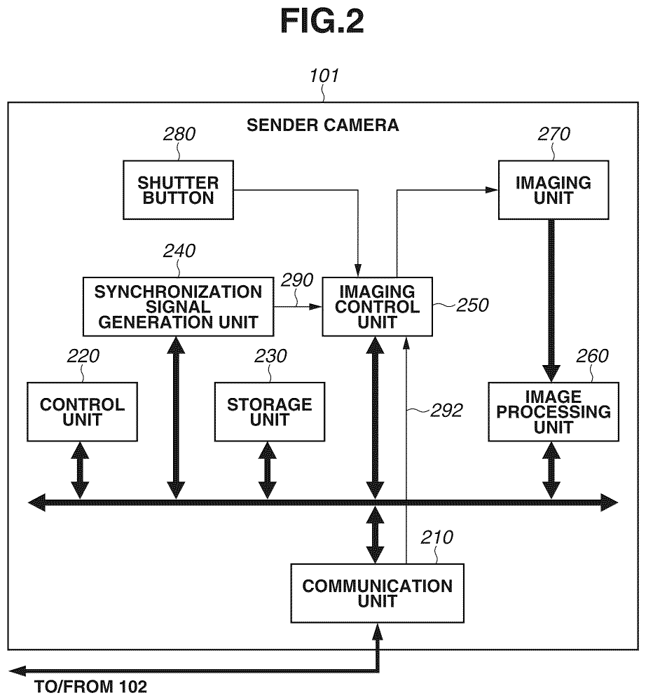

FIG. 2 is a block diagram illustrating a configuration example of the sender camera 101. The sender camera 101 has a communication unit 210, a control unit 220, a storage unit 230, a synchronization signal generation unit 240, an imaging control unit 250, an image processing unit 260, an imaging unit 270, and a shutter button 280. These components are controlled by the control unit 220. The components 210 to 260 communicate with each other via a system bus to exchange various types of control information, image information, and the like. The sender camera 101 is connected to the receiver cameras 102a to 102f via the communication unit 210.

The communication unit 210 is a communication interface that communicates with the receiver cameras 102a to 102f. The communication interface includes a media access control (MAC) or a physical layer (PHY). The communication unit 210 has a communication function and a clock function.

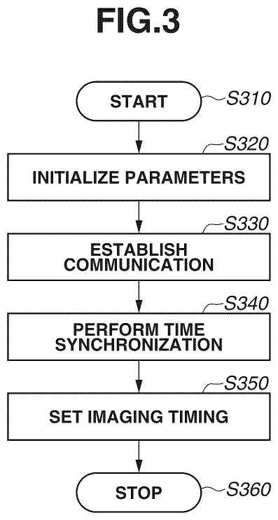

The communication function corresponds to step S330 in FIG. 3, and is the function of forming a communication path with each camera in FIG. 1 to transmit and receive communication packets according to a communication protocol. In the case of the sender camera 101, a trigger signal that is an instruction to start imaging is packetized and transmitted from the communication unit 210. The same fixed value is always used for the trigger signal.

The clock function is used in an operation of step S340 in FIG. 3. The clock function is synchronized with an internal counter of the synchronization signal generation unit 240 via the system bus.

The control unit 220 is a central processing unit (CPU) that controls each component. Examples of the control include execution of a time synchronization sequence defined based on a time synchronization protocol, decoding of packets received by the communication unit 210, execution of the OS, and the like. The control unit 220 sets time information obtained from the communication unit 210 via the system bus to the synchronization signal generation unit 240.

The storage unit 230 is a main storage device that can be used in common by each component, and includes mainly a semiconductor memory, such as a dynamic random access memory (DRAM). The storage unit 230 stores various types of information to be handled by the components 210 to 270.

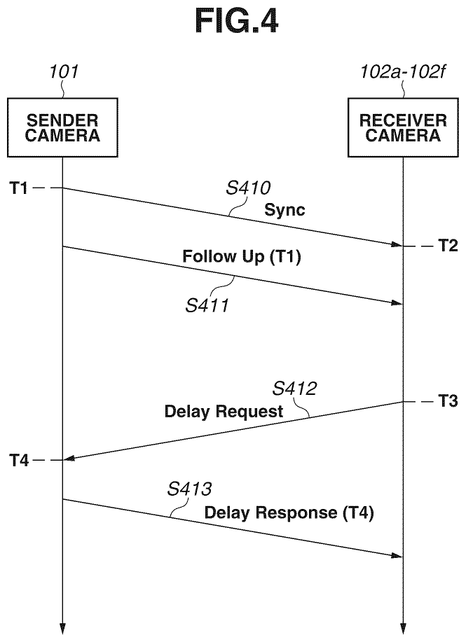

The synchronization signal generation unit 240 receives information from the clock function of the communication unit 210 and generates an imaging timing that is the basis of synchronous imaging for the imaging control unit 250. Examples of the imaging timing include pulse per second (PPS) or the like that has accurate intervals and ratios. The synchronization signal generation unit 240 has an internal counter for generating an imaging timing, and the counter value is updated by a notification from the communication unit 210 each time the sequence of FIG. 4 is performed. Thus, the values of the internal counters of the synchronization signal generation units 240 in the cameras are aligned.

The imaging control unit 250 drives the imaging unit 270 to perform imaging based on an imaging instruction from the shutter button 280 or the communication unit 210. The imaging control unit 250 is directly coupled to the synchronization signal generation unit 240 by a notification line 290 and receives an imaging timing. In receiving an imaging instruction from the shutter button 280, the imaging control unit 250 waits for imaging and then drives the imaging unit 270 at the timing notified via the notification line 290.

The image processing unit 260 processes image data sent from the imaging unit 270. The image processing unit 260 performs appropriate image processing on the received image data, and outputs the processed image data to the storage unit 230 via the system bus.

The imaging unit 270 is a sensor that performs imaging in response to receiving an imaging instruction from the imaging control unit 250. The imaging unit 270 transmits captured image data to the image processing unit 260.

The shutter button 280 is a button that is to be pressed by a photographer holding the sender camera 101. The photographer communicates their intention of imaging to the synchronous imaging system 100 via the shutter button 280.

The notification line 290 is a notification line through which the synchronization signal generation unit 240 notifies an imaging timing to the imaging control unit 250.

The above is a description of the components of the sender camera 101. In the present exemplary embodiment, the receiver cameras 102a to 102f have the same configuration as that of the sender camera 101, so the operations of their components are basically identical. Differences will be described below.

In each of the receiver cameras 102a to 102f, the communication unit 210 determines whether the received communication packet is a trigger signal transmitted from the sender camera 101. The determination is made using pattern matching. In the pattern matching, the communication unit 210 detects whether the received communication packet matches a trigger signal pattern stored in advance. If the received communication packet matches the trigger signal pattern, the communication unit 210 issues a notification directly to the imaging control unit 250 via the notification line 292.

The imaging control unit 250 notifies the imaging timing via the notification line 292 instead of the shutter button 280.

The shutter button 280 may not be provided because the shutter button 280 is not used by the receiver cameras 102a to 102f.

The notification line 292 is a signal line for issuing a notification to the imaging control unit 250 when the communication unit 210 receives a trigger signal.

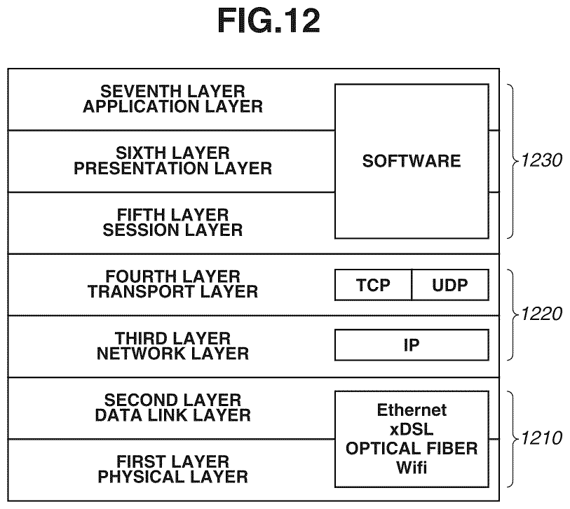

FIG. 12 is a diagram illustrating an Open Systems Interconnection (OSI) reference model which is used in the pattern matching process to be performed by the communication unit 210. The OSI is a network standard established by International Organization for Standardization (ISO) and International Telecommunication Union (ITU). The OSI reference model is a model of communications to be used in the OSI. Two methods for performing pattern matching using the OSI reference model will be described below.

A layer 1210 includes a physical layer and a data link layer, and is a communication protocol to be executed by MAC or PHY processing of the communication unit 210. In a case where information about the trigger signal is included in a data portion of the communication protocol used in the layer 1210, whether the data portion matches the trigger signal pattern stored in advance in the communication unit 210 is determined. If they match each other, the communication unit 210 issues a notification directly to the imaging control unit 250 via the notification line 292.

A layer 1220 includes a network layer and a transport layer, and is communication protocols based on Transmission Control Protocol (TCP), User Datagram Protocol (UDP), and Internet Protocol (IP) to be performed by the control unit 220. In a case where information about the trigger signal is included in a data portion of the communication protocol used in the layer 1220, the control unit 220 determines whether the data portion matches the trigger signal pattern stored in the storage unit 230. If they match each other, the control unit 220 issues a notification to the imaging control unit 250 via the system bus.

A layer 1230 includes a session layer, a presentation layer, and an application layer, and is a communication protocol of software executed in each camera. Pattern matching is not performed in the layer 1230.

In the OSI reference model, the processing speed is higher in lower layers. Processing received communication packets at the first and second layers, which are lower layers than the other layers, shortens the processing time to be taken to prepare imaging, as compared with a case where software processing is performed in higher layers.

FIG. 3 is a flowchart of initial setting executed by each camera in the synchronous imaging system 100 illustrated in FIG. 1. The flowchart illustrates the initial setting of each camera when the synchronous imaging system 100 performs synchronous imaging.

Start in step S310 indicates the starting point of the flowchart in FIG. 3. Step S310 indicates a state where each camera is activated as one of the terminals included in the synchronous imaging system 100 illustrated in FIG. 1.

In step S320, the control unit 220 of each camera performs a process of initializing parameters of the camera. The parameters are to be used for each camera to perform synchronous imaging in the synchronous imaging system 100 illustrated in FIG. 1. In the present exemplary embodiment, each camera has the same configuration, and which camera serves as the sender camera 101 and which cameras serve as the receiver cameras 102a to 102f are determined based on the parameters.

In step S330, the control unit 220 of each camera performs a process of establishing communication between each of the cameras using the communication function of the communication unit 210, to form the synchronous imaging system 100 illustrated in FIG. 1. Each of the cameras is connected to one another via the communication units 210, and is able to exchange time, data, and control information.

In step S340, the control unit 220 of each camera performs time synchronization illustrated in FIG. 4 with the clock function of the communication unit 210, thus performing process of synchronization of time. Specifically, the sequence illustrated in FIG. 4 is executed. As a result, the clocks in the communication units 210 of the cameras are synchronized.

After this process, the communication unit 210 executes the sequence illustrated in FIG. 4 at regular intervals under the control of the control unit 220. This enables each camera to periodically update the clock function of the communication unit 210 and the value of the counter in the synchronization signal generation unit 240.

In step S350, the control unit 220 of each camera causes the synchronization signal generation unit 240 to perform a process of setting an imaging timing. The imaging timing is generated by the counter in the synchronization signal generation unit 240 and is used for imaging. In response to the imaging timing having been generated in the synchronization signal generation unit 240, the synchronization signal generation unit 240 outputs a pulse from the notification line 290 to the imaging control unit 250.

Since the counter values in the synchronization signal generation units 240 of the cameras are aligned, the synchronized imaging timing is received by the imaging control units 250 of the cameras. The imaging timing is set to a level at which it is sufficient for communication and is unnoticeable by the photographer.

Stop in step S360 indicates the end of the process in the flowchart of FIG. 3.

FIG. 4 is a diagram illustrating a time synchronization sequence executed in each camera of the synchronous imaging system 100 illustrated in FIG. 1. More specifically, FIG. 4 illustrates the operation in step S340 illustrated in FIG. 3. In the time synchronization sequence in the present exemplary embodiment, Precision Time Protocol (PTP) is used.

The sequence in FIG. 4 is executed in a one-to-one relationship in which the sender camera 101 serves as a leader device and the receiver cameras 102a to 102f serve as follower devices. Herein, the respective receiver cameras 102a to 102f serving as the follower devices will be referred to as receiver camera 102.

In step S410, the sender camera 101 initially transmits a Sync packet that is a time synchronization packet.

In step S411, if the synchronization process of the sender camera 101 is performed in a 2-step synchronization process, the sender camera 101 transmits a Follow Up packet that is a time synchronization packet.

Here, the Sync/Follow Up packets are transmitted via multicast from the sender camera 101. The receiver camera 102 receives the Sync/Follow Up packets.

In step S412, in executing the synchronization process, the receiver camera 102 transmits a Delay Request packet that is a time synchronization packet to the sender camera 101. The sender camera 101 receives the Delay Request packet.

In step S413, the sender camera 101 transmits a Delay Response packet that is a time synchronization packet to the receiver camera 102. The receiver camera 102 receives the Delay Response packet.

Here, Time T1 indicates the time when the communication unit 210 of the sender camera 101 transmits the Sync packet. Time T2 indicates the time when the communication unit 210 of the receiver camera 102 receives the Sync packet. Time T3 indicates the time when the communication unit 210 of the receiver camera 102 transmits the Delay Request packet. Time T4 indicates the time when the communication unit 210 of the sender camera 101 receives the Delay Request packet.

The Follow Up packet stores the time T1, and the Delay Response packet holds the time T4.

The times T2 and T3 can be obtained through the procedure described below. The control unit 220 of the receiver camera 102 latches the internal clock of the communication unit 210 at the timing at which the communication unit 210 receives the Sync packet. This enables the control unit 220 to obtain the time T2.

With regard to the time T3, similarly, the control unit 220 latches the internal clock of the communication unit 210 at the timing at which the Delay Request packet is transmitted from the communication unit 210 of the receiver camera 102 to the sender camera 101. This enables the control unit 220 to obtain the time T3.

Execution of the above time synchronization sequence enables the receiver camera 102 to obtain the four times T1 to T4. From the information on these four times T1 to T4, it is possible to determine an average transmission path delay between the sender camera 101 and the receiver camera 102 and a time difference between the sender camera 101 and the receiver camera 102, specifically, a time correction amount for the receiver camera 102, as follows:

$$Average transmission path delay = ( ( T 4 - T 1 ) - ( T 3 - T 2 ) ) / 2 ; and$$

$$Time correction amount = ( ( T 2 - T 1 ) - ( T 4 - T 3 ) ) / 2 .$$

Since the time correction amount calculated as above is an offset amount of the receiver camera 102 relative to the sender camera 101, an advance amount of the internal counter of the synchronization signal generation unit 240 of the receiver camera 102 is adjusted such that the offset amount becomes zero. This realizes the time synchronization between the sender camera 101 and the receiver camera 102.

When time synchronization is performed in such a manner, the counter value of the sender camera 101 is synchronized with the counter value of the receiver camera 102. The synchronization signal generation unit 240 of the sender camera 101 generates an imaging timing based on the counter of the sender camera 101. The synchronization signal generation unit 240 of the receiver camera 102 generates an imaging timing based on the counter of the receiver camera 102. Thus, the imaging timing of the sender camera 101 and the imaging timing of the receiver camera 102 are synchronized with each other.

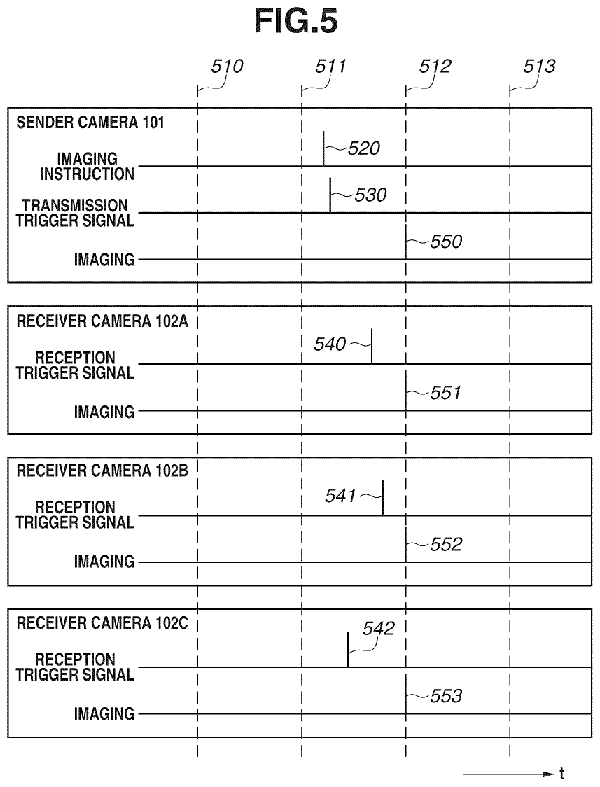

FIG. 5 is a diagram illustrating the timings at which the cameras illustrated in FIG. 1 perform synchronous imaging. For the sake of description, only the receiver cameras 102a to 102c are illustrated out of the receiver cameras 102a to 102f.

Broken lines 510 to 513 indicate the timings at which each camera performs imaging. The imaging timings are synchronized between the cameras through the operations in steps S340 and S350. Thus, the broken lines 510 to 513 indicate timings that are the same among the cameras. The timings of broken lines 510 to 513 are set at intervals that are sufficiently long with respect to the communication time between the sender camera 101 and the respective receiver cameras 102a to 102f.

The synchronization signal generation unit 240 of the sender camera 101 generates a periodic imaging timing that is synchronized with the receiver camera 102. The synchronization signal generation unit 240 of the receiver camera 102 generates a periodic imaging timing that is synchronized with the sender camera 101.

An imaging instruction 520 indicates the timing at which the shutter button 280 of the sender camera 101 is pressed, specifically, the timing at which an imaging instruction is received. The shutter button 280 notifies the imaging control unit 250 that the shutter button 280 has been pressed. The imaging control unit 250 is set such that imaging is to be performed at the next imaging timing (broken line 512) that is notified by the synchronization signal generation unit 240.

A transmission trigger signal 530 indicates a trigger signal that is transmitted from the sender camera 101 to the receiver cameras 102a to 102f. In response to the imaging instruction 520 being issued, the imaging control unit 250 issues a notification to the control unit 220 via the system bus. The control unit 220 generates the trigger signal 530 and transmits the trigger signal 530 from the communication unit 210 to the receiver cameras 102a to 102f.

Reception trigger signals 540 to 542 indicate timings at which the receiver cameras 102a to 102c receive the trigger signal 530. In response to arrival of the trigger signal 530 transmitted from the sender camera 101 at the communication units 210 of the receiver cameras 102a to 102c, each communication unit 210 determines, using pattern matching, that a packet has arrived and issues a notification to the imaging control unit 250 via the notification line 292.

In response to receiving the notification, the imaging control unit 250 is set such that imaging is to be performed at the next imaging timing (broken line 512) that is notified by the synchronization signal generation unit 240. This shortens the time for the control unit 220 to receive a packet via the system bus, determine the contents of the packet, and issue settings to the imaging control unit 250.

Imagings 550 to 553 indicate the timings when the imaging control units 250 of the cameras drive the imaging units 270 to perform imaging. Since each imaging control unit 250 is set such that “imaging is to be performed at the next imaging timing” at the timing of the imaging instruction 520, the imaging control unit 250 issues a notification to the imaging unit 270 at the imaging timing indicated by the broken line 512 which is the next imaging timing. In response to receiving the notification from the imaging control unit 250, the imaging unit 270 performs imaging, and the image processing unit 260 records, in the storage unit 230, the image data having undergone image processing. Since each camera is set such that imaging is performed at the next imaging timing in response to the imaging instruction 520 and the reception trigger signals 540 to 542, each camera performs imaging simultaneously at the timing indicated by the broken line 512.

Through the above processing, the sender camera 101 and the receiver cameras 102a to 102c perform imaging at the timing indicated by the broken line 512. Due to the time synchronization in step S340 and the setting of the imaging timing in step S350, the timings of the broken lines 510 to 513 are set to be the same for the cameras, so that the cameras can perform imaging in synchronization.

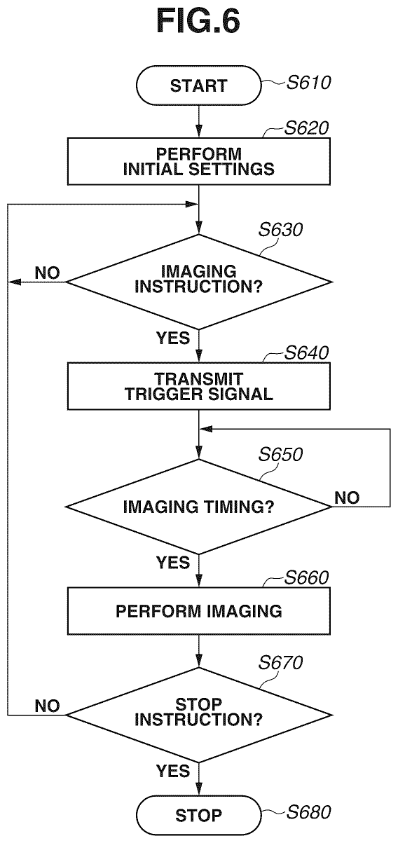

FIG. 6 is a flowchart of synchronization imaging to be performed by the sender camera 101 in the synchronous imaging system 100 illustrated in FIG. 1. A control method of the sender camera 101 will be described below.

Start in step S610 indicates the starting point of the process in the flowchart in FIG. 6. Step S610 indicates a state where the sender camera 101 is activated as one of the terminals included in the synchronous imaging system 100 illustrated in FIG. 1.

In step S620, the sender camera 101 executes the initial setting processing illustrated in FIG. 3. The communication unit 210 of the sender camera 101 establishes connections with the receiver cameras 102a to 102f and performs time synchronization, and the synchronization signal generation unit 240 periodically transmits an imaging timing to the imaging control unit 250.

In step S630, the imaging control unit 250 of the sender camera 101 performs a route selection based on the condition of an imaging instruction from the shutter button 280. If an imaging instruction has been issued from the shutter button 280 (YES in step S630), the processing proceeds to step S640. If not (NO in step S630), the current state is maintained.

In step S640, the control unit 220 of the sender camera 101 transmits a trigger signal to the receiver cameras 102a to 102f by the communication unit 210. The imaging control unit 250 notifies the control unit 220 via the bus that the shutter button 280 has been pressed. In response, the control unit 220 generates a trigger signal and transmits the trigger signal using the communication unit 210.

In step S650, the imaging control unit 250 of the sender camera 101 performs a route selection based on whether an imaging timing has been generated. If an imaging timing has been generated by the synchronization signal generation unit 240 (YES in step S650), the processing proceeds to step S660, and if not (NO in step S650), the current state is maintained.

In step S660, the imaging control unit 250 of the sender camera 101 performs control to drive the imaging unit 270 to perform imaging at the imaging timing generated in step S650.

In step S670, the control unit 220 of the sender camera 101 performs a route selection based on whether an instruction to stop the sender camera 101 has been issued. If an instruction to stop synchronous imaging has been issued from the user or the like (YES in step S670), the processing proceeds to step S680, and if not (NO in step S670), the processing proceeds to step S630.

Stop in step S680 indicates the end of the processing in the flowchart of FIG. 6.

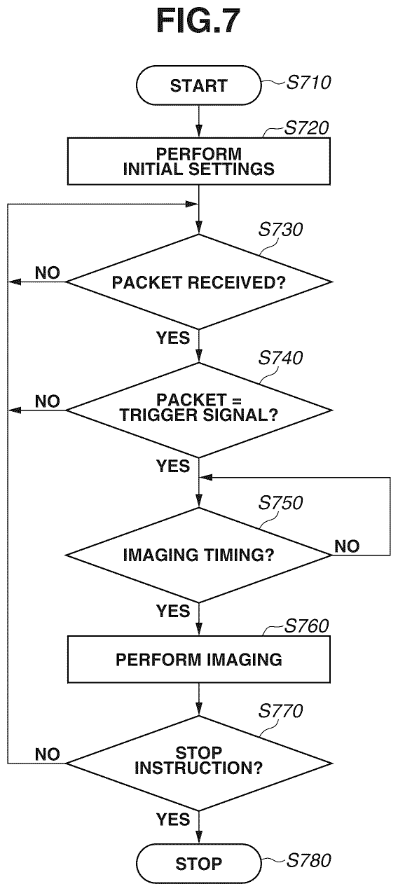

FIG. 7 is a flowchart of synchronous imaging to be performed by the receiver cameras 102a to 102f in the synchronous imaging system 100 illustrated in FIG. 1. A control method for the receiver cameras 102a to 102f will be described below.

Start in step S710 indicates the starting point of the processing in the flowchart in FIG. 7. Step S710 indicates a state in which the receiver cameras 102a to 102f are each activated as one of the terminals included in the synchronous imaging system 100 illustrated in FIG. 1.

In step S720, the receiver cameras 102a to 102f execute the initial setting processing illustrated in FIG. 3. The communication units 210 of the receiver cameras 102a to 102f each establish a connection with the sender camera 101 and perform time synchronization. The synchronization signal generation units 240 of the receiver cameras 102a to 102f each periodically transmit an imaging timing to the imaging control units 250.

In step S730, the communication units 210 of the receiver cameras 102a to 102f performs a route selection based on whether a packet has been received from the outside. If the communication units 210 have received a packet (YES in step S730), the processing proceeds to step S740, and if not (NO in step S730), the current state is maintained.

In step S740, the communication units 210 of the receiver cameras 102a to 102f perform a route selection based on a determination using pattern matching as to whether the packet received in step S730 is a trigger signal. If the received packet is a trigger signal (YES in step S740), each communication unit 210 issues a notification to the imaging control unit 250 via the notification line 292, and the processing proceeds to step S750, and if not (NO in step S740), the processing proceeds to step S730.

In step S750, the imaging control units 250 of the receiver cameras 102a to 102f performs a route selection based on whether an imaging timing has been generated.

If an imaging timing has been generated by each synchronization signal generation unit 240 (YES in step S750), the process proceeds to step S760, and if not (NO in step S750), the current state is maintained.

In step S760, the imaging control units 250 of the receiver cameras 102a to 102f performs control to drive the imaging units 270 to perform imaging at the imaging timing generated in step S750.

In step S770, the control units 220 of the receiver cameras 102a-102f perform a route selection based on whether an instruction to stop the receiver cameras 102a to 102f has been issued. If the instruction to stop the synchronous imaging has been issued by the user or the like (YES in step S770), the process proceeds to stop S780, and if not (NO in step S770), the process proceeds to step S730.

Stop in step S780 indicates the end of the processing in the flowchart of FIG. 7.

A second exemplary embodiment will be described below. In the second exemplary embodiment, an imaging control unit 250 of a sender camera 101 illustrated in FIG. 2 has an internal imaging timing counter. The imaging timing counter is a counter that measures time from one imaging timing to the next imaging timing, and is reset when the imaging timing is received from a synchronization signal generation unit 240.

The imaging control unit 250 grasps, using the imaging timing counter, a timing of the issuance of the imaging instruction from a shutter button 280 in the imaging timing. A storage unit 230 stores a prescribed value, and notifies the prescribed value via the system bus to the imaging control unit 250. The prescribed value here refers to a value set to be an interval between when the shutter button 280 is pressed and when receiver cameras 102a to 102f, serving as end-use devices, are put on standby for imaging such that the next imaging timing is in time. The specified value may be set to the storage unit 230 with a user operation, or may be set from an external device via a communication unit 210.

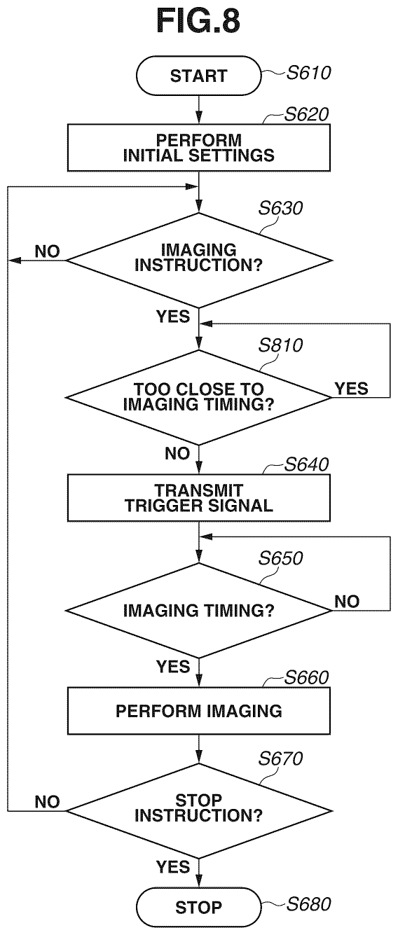

FIG. 8 is a flowchart in which the relationship between the imaging instruction and the imaging timing is reflected in the flowchart in FIG. 6. The flowchart in FIG. 8 is a flowchart in which step S810 is added to the flowchart in FIG. 6. The processing in FIG. 8 is the same as the processing in FIG. 6 except for the aspects otherwise specified, and only differences will be described.

In step S630, if the imaging control unit 250 of the sender camera 101 determines that an imaging instruction has been issued from the shutter button 280 (YES in step S630), the processing proceeds to step S810.

In step S810, the imaging control unit 250 of the sender camera 101 performs a route selection based on whether the value of the imaging timing counter is equal to or less than the prescribed value when the shutter button 280 is pressed. If the value of the imaging timing counter is equal to or less than the prescribed value (NO in step S810), the processing proceeds to step S640, and if not (YES in step S810), the current state is maintained.

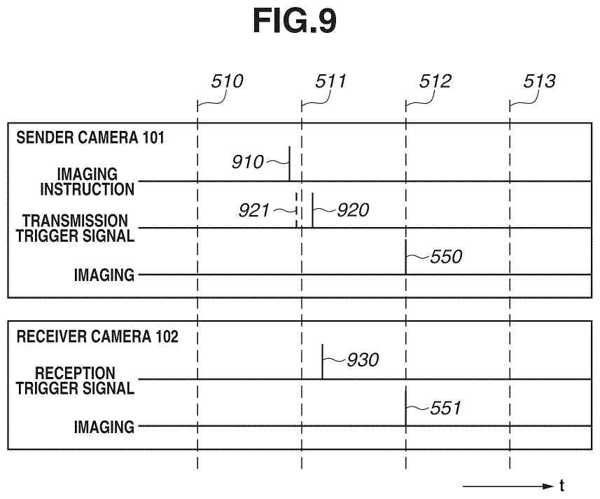

FIG. 9 is a diagram illustrating the timings at which the cameras in FIG. 1 perform synchronous imaging. For the sake of description, receiver cameras 102a to 102f are represented as a receiver camera 102. The processing in FIG. 9 is the same as the processing in FIG. 5 except for the aspects otherwise specified, and only differences will be described.

An imaging instruction 910 indicates the timing at which the shutter button 280 of the sender camera 101 is pressed. The value of the imaging timing counter at the time when the shutter button 280 is pressed is greater than the prescribed value. In step S810, the imaging control unit 250 waits until the value of the imaging timing counter is reset and falls smaller than the prescribed value.

A broken line 921 indicates the timing at which a trigger signal would normally be transmitted if step S810 is not present. In receiving the imaging instruction 910, the sender camera 101 immediately transmits a trigger signal and is set to “perform imaging at the next imaging timing”. In this case, imaging is performed at the timing indicated by a broken line 511.

A transmission trigger signal 920 is a trigger signal that is transmitted from the sender camera 101 to the receiver cameras 102a to 102f. In step S810, the imaging control unit 250 waits until the timing after the broken line 511, and the communication unit 210 transmits the trigger signal 920 to the receiver camera 102. The sender camera 101 performs imaging 550 at the timing indicated by a broken line 512.

Thus, the receiver camera 102 receives the trigger signal at the timing indicated by a reception trigger signal 930, and performs imaging 551 at the timing indicated by the broken line 512.

The reception trigger signal 930 indicates the timing at which the trigger signal is received by the receiver camera 102. Since the transmission trigger signal 920 from the sender camera 101 is delayed in step S810, the imaging 551 is performed at the same timing indicated by the broken line 512 as that of the sender camera 101 without a change to the processing of the receiver camera 102.

As described above, in step S640, when the interval between the imaging timing immediately before the imaging instruction and the current time is equal to or less than a first threshold, the communication unit 210 transmits a trigger signal to the receiver camera 102 such that the receiver camera 102 receives the trigger signal before the imaging timing that is immediately after the imaging instruction. The first threshold is a prescribed value, for example. When the interval between the imaging timing immediately before the imaging instruction and the current time is longer than the first threshold, the communication unit 210 transmits a trigger signal to the receiver camera 102 such that the receiver camera 102 receives the trigger signal after the imaging timing that is immediately after the imaging instruction.

More specifically, when the interval between the imaging timing immediately before the imaging instruction and the current time is equal to or less than the first threshold, the communication unit 210 transmits a trigger signal to the receiver camera 102 before the imaging timing that is immediately after the imaging instruction. When the interval between the imaging timing immediately before the imaging instruction and the current time is longer than the first threshold, the communication unit 210 transmits a trigger signal to the receiver camera 102 after the imaging timing that is immediately after the imaging instruction.

A third exemplary embodiment will be described below. A sender camera 101 in the third exemplary embodiment has an imaging timing counter and a prescribed value, as in the sender camera 101 in the second exemplary embodiment.

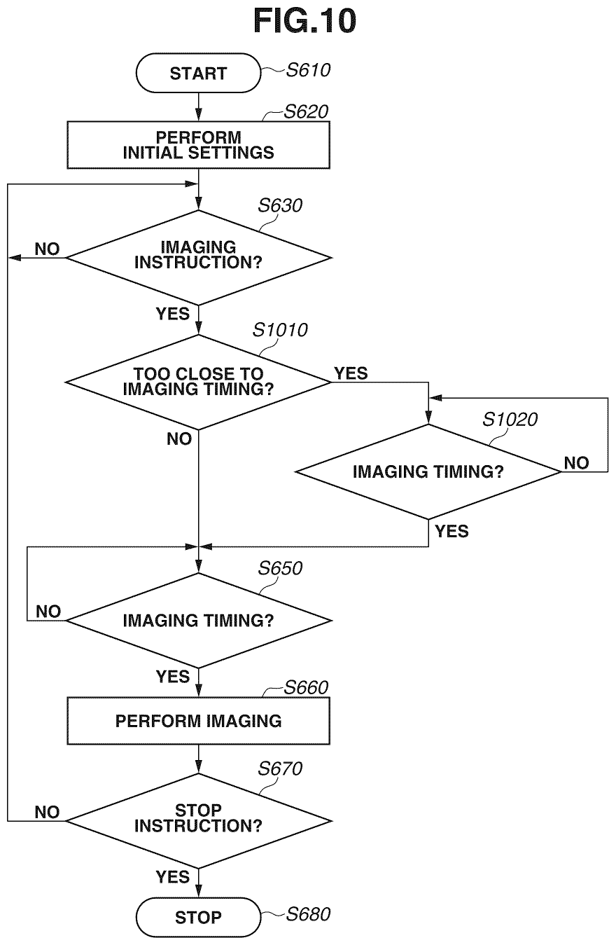

FIG. 10 is a flowchart with the relationship between the imaging instruction and the imaging timing reflected in the flowchart in FIG. 6. The flowchart in FIG. 10 is a flowchart in which steps S1010 and S1020 are added to the flowchart in FIG. 6. The processing in FIG. 10 is the same as the process in FIG. 6 except for the aspects otherwise specified, and only the differences will be described.

After step S630, the processing proceeds to step S1010.

In step S1010, an imaging control unit 250 of the sender camera 101 performs a route selection based on whether the value of an imaging timing counter is equal to or less than the prescribed value when a shutter button 280 is pressed. The prescribed value here refers to a value set to be an interval between when the shutter button 280 is pressed and when receiver cameras 102a to 102f, serving as end-use devices, are put on standby for imaging such that the next imaging timing is in time.

If the value of the imaging timing counter is equal to or less than the prescribed value (NO in step S1010), the processing proceeds to step S650, and if not (YES in step S1010), the processing proceeds to step S1020.

In step S1020, the imaging control unit 250 of the sender camera 101 performs a route selection based on whether the imaging timing has been reached. If the imaging control unit 250 receives the imaging timing from a synchronization signal generation unit 240 (YES in step S1020), the processing proceeds to step S650, and if not (NO in step S1020), the current state is maintained.

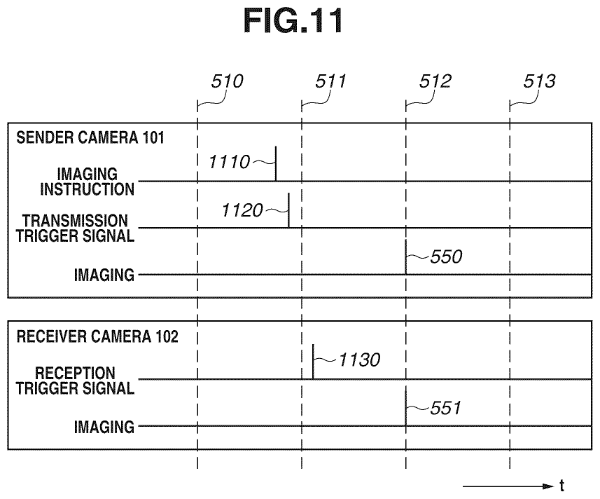

FIG. 11 is a diagram illustrating the timings at which each camera in FIG. 1 performs synchronous imaging. For the sake of description, the receiver cameras 102a to 102f are denoted as a receiver camera 102. The processing in FIG. 11 is the same as the processing in FIG. 5 except for the aspects otherwise specified, and only differences will be described.

An imaging instruction 1110 illustrates the timing at which the shutter button 280 of the sender camera 101 is pressed.

A transmission trigger signal 1120 indicates a trigger signal to be transmitted from the sender camera 101 to the receiver cameras 102a to 102f. The value of the imaging timing counter is greater than the prescribed value, and if the processing is continued in this state, imaging would be performed at the timing of a broken line 511.

On the other hand, the receiver camera 102 receives a trigger signal at the timing indicated by a reception trigger signal 1130 across the broken line 511, and performs imaging 551 at the timing indicated by a broken line 512.

Thus, in step S1020, the sender camera 101 does not perform imaging at the timing indicated by the broken line 511, and in the following step S650, the sender camera 101 performs imaging 550 at the timing indicated by the broken line 512.

The reception trigger signal 1130 indicates the timing at which the receiver camera 102 receives a trigger signal. The timing of the reception trigger signal 1130 is set after the timing indicated by the broken line 511 due to a communication delay. The receiver camera 102 performs imaging 551 at the timing of the broken line 512.

As described above, even if the transmission and reception of the trigger signal are performed across the imaging timing, the sender camera 101 skips imaging, so that each camera performs imaging at the same timing.

As described above, in step S660, when the interval between the imaging timing immediately before the imaging instruction and the current time is equal to or less than a second threshold, the imaging control unit 250 performs control such that imaging is performed at the imaging timing immediately after the transmission of the trigger signal. The second threshold is a prescribed value, for example. When the interval between the imaging timing immediately before the imaging instruction and the current time is longer than the second threshold, the imaging control unit 250 performs control such that imaging is performed at the second-subsequent imaging timing after transmissions of the trigger signal.

According to the first to third exemplary embodiments, the synchronous imaging system 100 brings the imaging timing intended by the user closer to the actual imaging timing, thus enabling synchronous imaging close to the timing intended by the user.

### OTHER EMBODIMENTS

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

The above-described exemplary embodiments are merely illustrative of specific examples of implementing the present disclosure, and the technical scope of the present disclosure should not be interpreted as being limited by these exemplary embodiments. That is, the present disclosure can be implemented in various forms without departing from its technical concept or main features.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2023-192528, filed Nov. 10, 2023, which is hereby incorporated by reference herein in its entirety.

What is claimed is:

1. An imaging system comprising:
a first imaging apparatus; and
a second imaging apparatus,
wherein the first imaging apparatus includes:
a first generation unit configured to generate a periodic imaging timing synchronized with the second imaging apparatus;
a first communication unit configured to transmit a trigger signal to the second imaging apparatus based on an imaging instruction; and
a first imaging control unit configured to perform control such that imaging is performed at the imaging timing generated by the first generation unit after the trigger signal is transmitted, and
wherein the second imaging apparatus includes:
a second generation unit configured to generate a periodic imaging timing synchronized with the first imaging apparatus;
a second communication unit configured to receive the trigger signal from the first imaging apparatus; and
a second imaging control unit configured to perform control such that imaging is performed at the imaging timing generated by the second generation unit after the trigger signal is received.

2. The imaging system according to claim 1,
wherein, in a case where an interval between an imaging timing immediately before the imaging instruction and a current time is equal to or less than a first threshold, the first communication unit transmits the trigger signal to the second imaging apparatus such that the second imaging apparatus receives the trigger signal before an imaging timing that is immediately after the imaging instruction, and
wherein, in a case where the interval between the imaging timing immediately before the imaging instruction and the current time is longer than the first threshold, the first communication unit transmits the trigger signal to the second imaging apparatus such that the second imaging apparatus receives the trigger signal after the imaging timing that is immediately after the imaging instruction.

3. The imaging system according to claim 2,
wherein, in a case where the interval between the imaging timing immediately before the imaging instruction and the current time is equal to or less than the first threshold, the first communication unit transmits the trigger signal to the second imaging apparatus before the imaging timing that is immediately after the imaging instruction, and
wherein, in a case where the interval between the imaging timing immediately before the imaging instruction and the current time is longer than the first threshold, the first communication unit transmits the trigger signal to the second imaging apparatus after the imaging timing that is immediately after the imaging instruction.

4. The imaging system according to claim 1,
wherein, in a case where an interval between an imaging timing immediately before the imaging instruction and a current time is equal to or less than a second threshold, the first imaging control unit performs control such that imaging is performed at an imaging timing that is immediately after the trigger signal is transmitted, and
wherein, in a case where the interval between the imaging timing immediately before the imaging instruction and the current time is longer than the second threshold, the first imaging control unit performs control such that imaging is performed at a second subsequent imaging timing after the trigger signal is transmitted.

5. The imaging system according to claim 1, wherein the second communication unit determines whether a packet received from the first imaging apparatus is a trigger signal.

6. The imaging system according to claim 5, wherein the second communication unit determines, using pattern matching, whether the packet received from the first imaging apparatus is a trigger signal.

7. The imaging system according to claim 1, wherein the first generation unit and the second generation unit synchronize an imaging timing using Precision Time Protocol (PTP).

8. The imaging system according to claim 1,
wherein the first generation unit generates an imaging timing based on a counter of the first imaging apparatus,
wherein the second generation unit generates an imaging timing based on a counter of the second imaging apparatus, and
wherein the counter of the first imaging apparatus and the counter of the second imaging apparatus are synchronized with each other.

9. The imaging system according to claim 8, wherein a value of the counter of the second imaging apparatus is corrected based on a time when the first imaging apparatus transmits a first packet, a time when the second imaging apparatus receives the first packet, a time when the second imaging apparatus transmits a second packet, and a time when the first imaging apparatus receives the second packet.

10. The imaging system according to claim 1, wherein the imaging instruction is issued with a shutter button.

11. An imaging apparatus comprising:
a generation unit configured to generate a periodic imaging timing synchronized with another imaging apparatus;
a communication unit configured to transmit a trigger signal to the another imaging apparatus based on an imaging instruction; and
an imaging control unit configured to perform control such that imaging is performed at the imaging timing generated by the generation unit after the trigger signal is transmitted.

12. An imaging apparatus comprising:
a generation unit configured to generate a periodic imaging timing synchronized with another imaging apparatus;
a communication unit configured to receive a trigger signal from the another imaging apparatus; and
an imaging control unit configured to perform control such that imaging is performed at the imaging timing generated by the generation unit after the trigger signal is received.

13. A method for controlling an imaging system including a first imaging apparatus and a second imaging apparatus, the method comprising:
causing the first imaging apparatus to generate a periodic imaging timing synchronized with the second imaging apparatus;
causing the first imaging apparatus to transmit a trigger signal to the second imaging apparatus based on an imaging instruction; and
performing control such that the first imaging apparatus performs imaging at the imaging timing generated by the first imaging apparatus after the trigger signal is transmitted, and
causing the second imaging apparatus to generate a periodic imaging timing synchronized with the first imaging apparatus;
causing the second imaging apparatus to receive the trigger signal from the first imaging apparatus; and
performing control such that the second imaging apparatus performs imaging at the imaging timing generated by the second imaging apparatus after the trigger signal is received.

14. A method for controlling an imaging apparatus, the method comprising:
generating a periodic imaging timing synchronized with another imaging apparatus;
transmitting a trigger signal to the another imaging apparatus based on an imaging instruction; and
performing control such that imaging is performed at the generated imaging timing after the trigger signal is transmitted.

15. A method for controlling an imaging apparatus, the method comprising:
generating a periodic imaging timing synchronized with another imaging apparatus;
receiving a trigger signal from the another imaging apparatus; and
performing control such that imaging is performed at the generated imaging timing after the trigger signal is received.

16. A non-transitory computer-readable storage medium storing instructions that, when executed by a computer, cause the computer to perform a method for controlling an imaging apparatus, the method comprising:
generating a periodic imaging timing synchronized with another imaging apparatus;
transmitting a trigger signal to the another imaging apparatus based on an imaging instruction; and
performing control such that imaging is performed at the generated imaging timing after the trigger signal is transmitted.

17. A non-transitory computer-readable storage medium storing instructions that, when executed by a computer, cause the computer to perform a method for controlling an imaging apparatus, the method comprising:
generating a periodic imaging timing synchronized with another imaging apparatus;
receiving a trigger signal from the another imaging apparatus; and
performing control such that imaging is performed at the generated imaging timing after the trigger signal is received.
